(19) United States
(12) Patent Application Publication
(10) Pub. No.: US 2017/0208923 A1
(43) Pub. Date: Jul. 27, 2017

(54) Method and system of fastening a belt with interchangeable adornments and bags.

(71) Applicant: Sharon L. Buechner, Madison, WI (US)

(72) Inventor: Sharon L. Buechner, Madison, WI (US)

(21) Appl. No.: 15/003,989

(22) Filed: Jan. 22, 2016

(51) Int. Cl. A45F 3/00; F16B 1/00

(52) U.S. Cl. CPC A45F 3/005; F16B 1/00; F16B 2001/0028; F16B 2001/0035

(57) ABSTRACT

A child-friendly, securely fastening children's apparel accessory and carrier system, with accompanying interchangeable design pieces which the child may attach and arrange on the accessory.

### FIELD OF THE INVENTION

The invention relates a belt system, and method of using said system, with user-removable, interchangeable adornments and bags. More specifically, the present invention relates to interchangeable adornments and bags which can be removably attached on a belt.

### BACKGROUND OF THE INVENTION

It is known in the prior art to accent fashion articles, such as headbands, barrettes, hand bags, purses, belts or caps, with an adornment which can be removably attached to the fashion article to allow replacement with a different adornment. Such interchangeable attachments typically include a front wall having a show surface and a back wall having a securing member adapted to engage a connection means on the article for removably attaching the interchangeable attachment to the article. However, these systems are superficial to the article to which they attach, and do not provide any additional security to the fastening of the article. The previous fashion articles themselves, such as belts and purses, could not be easily operated by a child. Many of the fastening mechanisms were complicated or required more strength than what a child is capable of A new fastening and carrier system was needed to allow a child to use the fashion article, including the interchangeable adornments, without assistance from an adult.

### BRIEF SUMMARY OF THE INVENTION

A system and method of fastening a belt with user-removable, interchangeable adornments and bags is disclosed. Various embodiments are intended to provide for a system and method for a child user to operate and wear a belt with removable, interchangeable adornments and bags. This device is intended to allow a user with limited dexterity and strength, such as a child, to securely fasten the device around the user without assistance. This is achieved by using multiple redundant fasteners requiring less strength to operate than if just one closure were used. Each of these fasteners has a fastening and detachment force such that it may be operated by a child.

More specifically, in the preferred embodiment of the invention, the adornment or bag attachments spans across the two ends of the belt closure, providing the additional fastening security. The preferred embodiment of the invention includes multiple bags and adornment elements which attach to one or more of the fasteners and are interchangeable with one another. Virtually limitless types and configurations of adornments and bags may be used. In certain embodiments, an adornment may consist of, or may comprise, a bow, an artificial flower, a gem, an artificial gem, a bead, or a representation of a plant, flower, animal, or character.

These and other aspects and advantages of the invention will become apparent to a person of ordinary skill in the art upon review of the written description set forth herein and the accompanying drawings.

### BRIEF DESCRIPTION OF THE DRAWINGS

The accompanying drawings, which are incorporated in and constitute a part of this specification, illustrate some embodiments of the invention and, together with the detailed description and all other parts of this patent application serve to explain the principles of the invention.

FIG. 1 is a view of one embodiment of the invention showing the invention with the support member attached to the pouch.

FIG. 2 is a view of one embodiment of the invention showing both the front and back of the support member.

FIG. 3 is a view of one embodiment of the invention showing the various adornment elements attached to support members.

FIG. 4 is a schematic view of one embodiment of the invention showing the support member alone, the support belt with a pouch attached, and a support belt with adornment elements attached.

FIG. 5 is a schematic view of one embodiment of the invention showing the front, side, and back of the pouch.

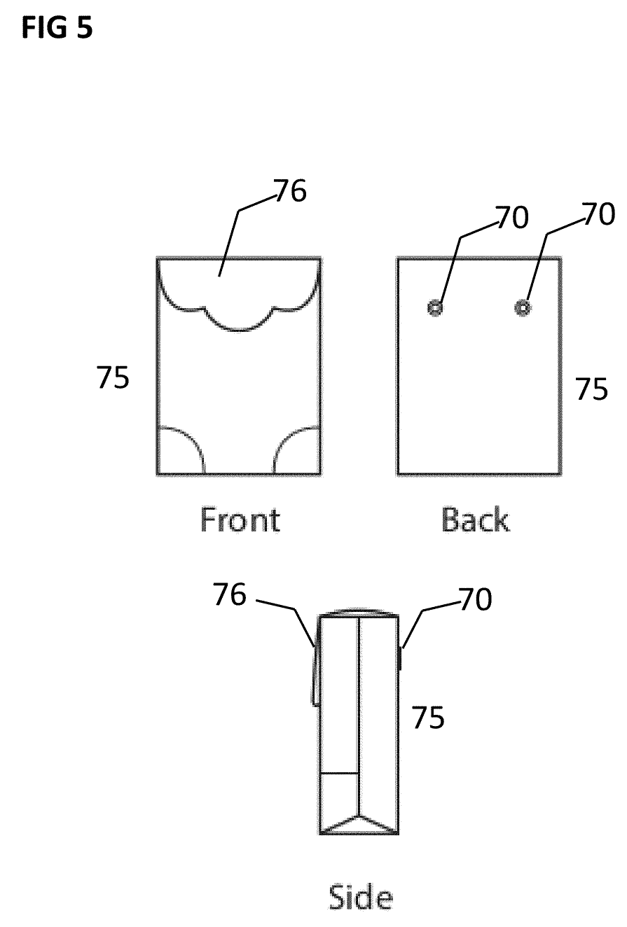

FIG. 6 is a schematic view of one embodiment of the invention showing examples of adornment elements.

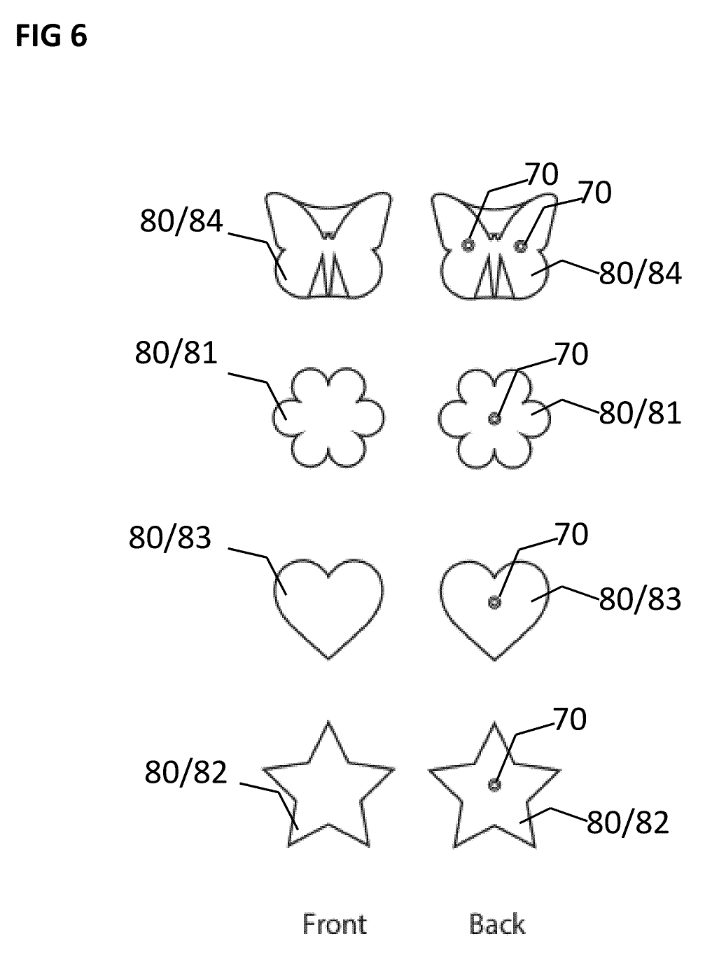

FIG. 7 is a schematic view of one embodiment of the invention showing the three layer construction of the flower adornment element.

FIG. 8 is a schematic view of the one embodiment of the invention showing the three layer construction of the star adornment element.

FIG. 9 is a schematic view of one embodiment of the invention showing the three layer construction of the heart adornment element.

FIG. 10 is a schematic view of one embodiment of the invention sowing the three layer construction of the butterfly adornment element.

FIG. 11 is a schematic view of one embodiment of the invention showing the creature adornment element.

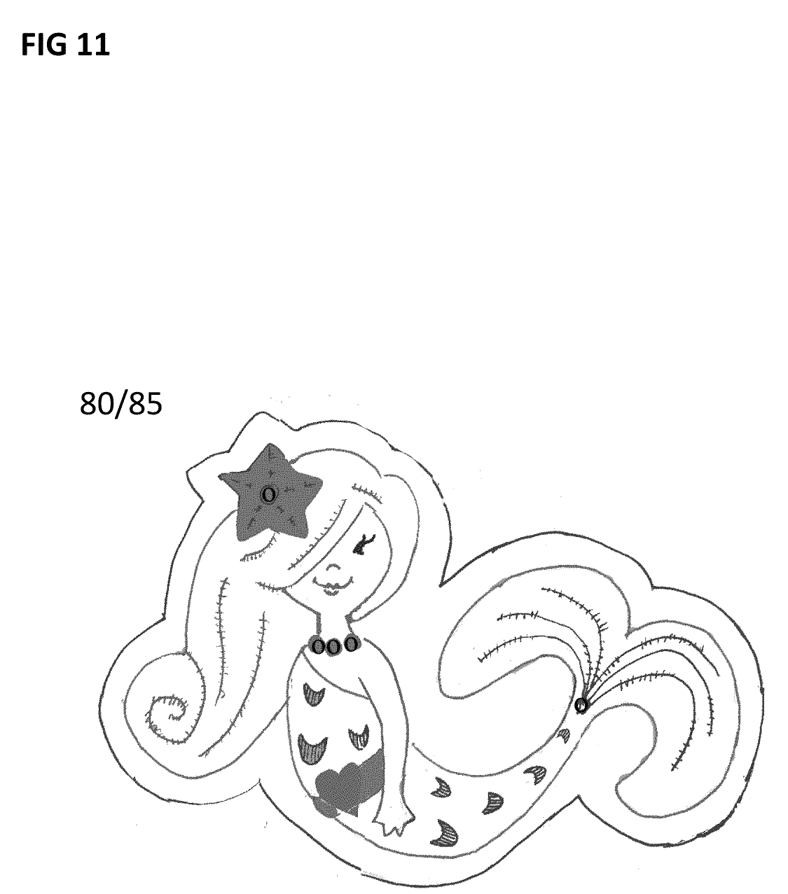

FIG. 12 is a schematic view of one embodiment of the invention showing the support member and pouch.

FIG. 13 is a schematic view of one embodiment of the invention showing the back of the attachment pouch, with the support member securely fastened to itself

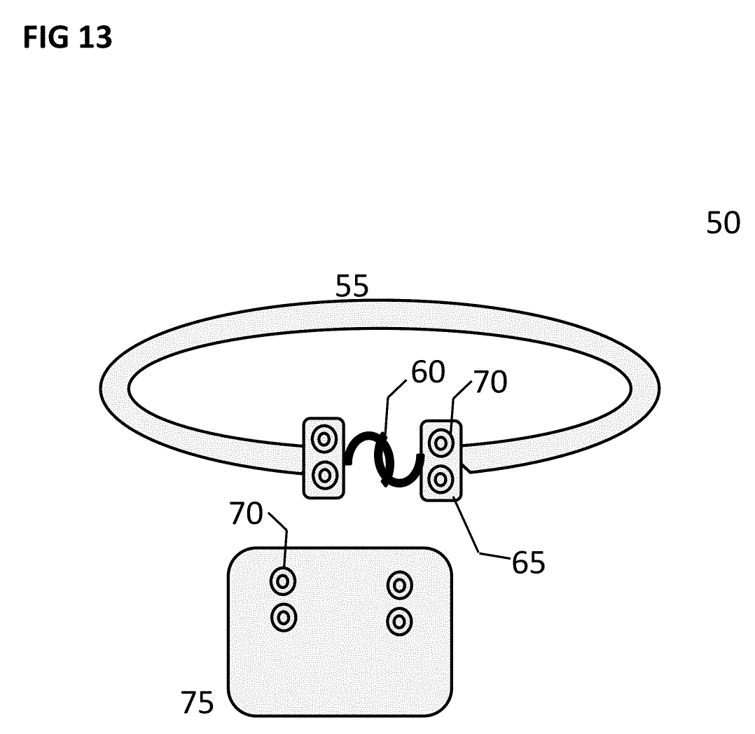

FIG. 14 is a schematic view of one embodiment of the invention showing the attachment pouch securely fastened across the fastening mechanism of the support member.

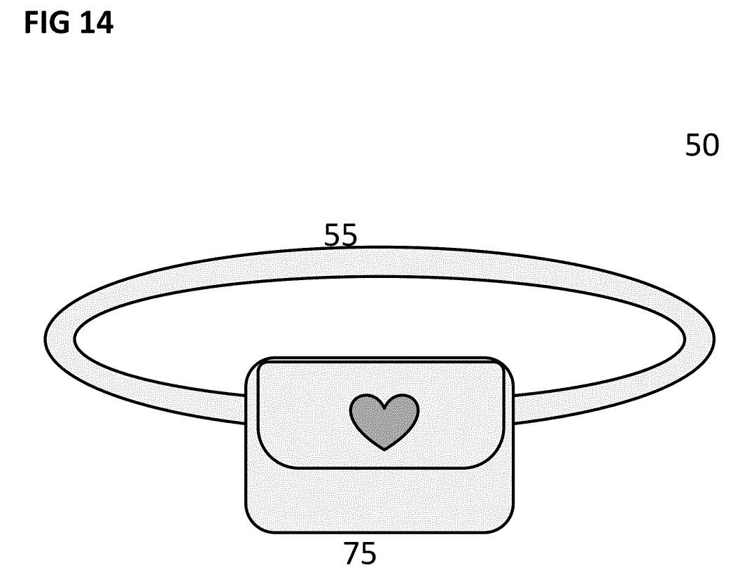

FIG. 15 is a schematic view of one embodiment of the invention showing a different attachment pouch attached to the support member.

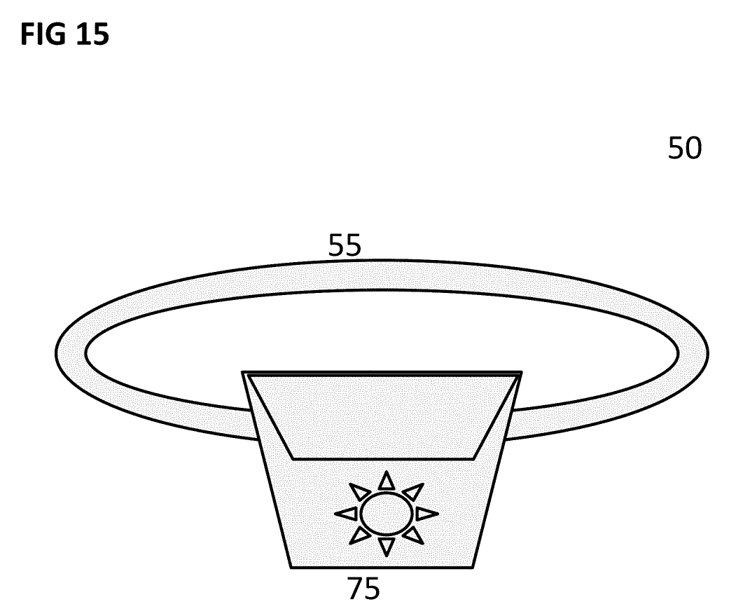

FIG. 16 is a schematic view of one embodiment of the invention with the attachment pouch separated from an unfastened support member.

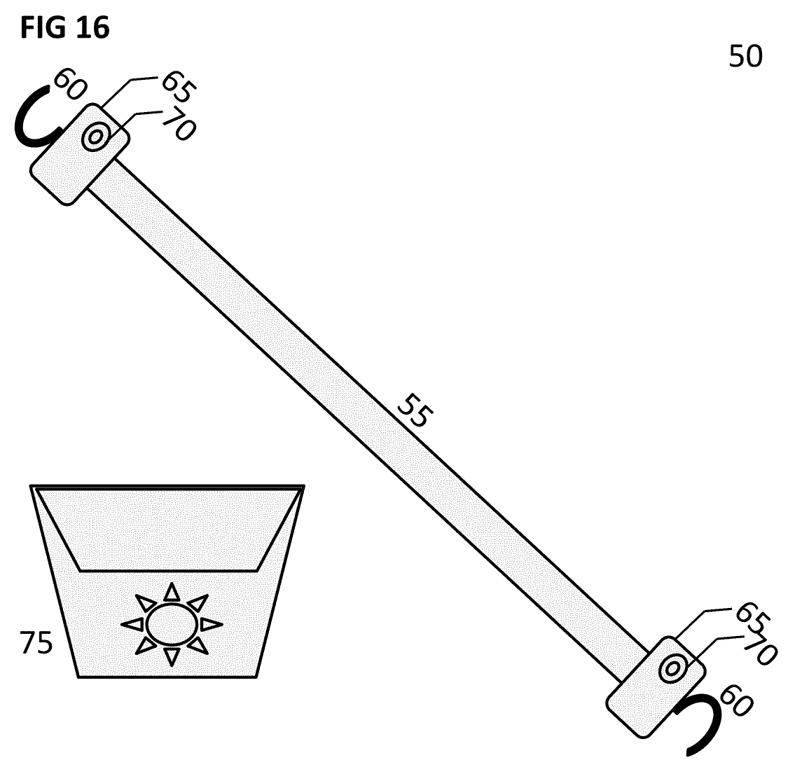

FIG. 17 is a schematic view of one embodiment of the invention showing the support member and one set of interchangeable adornment elements.

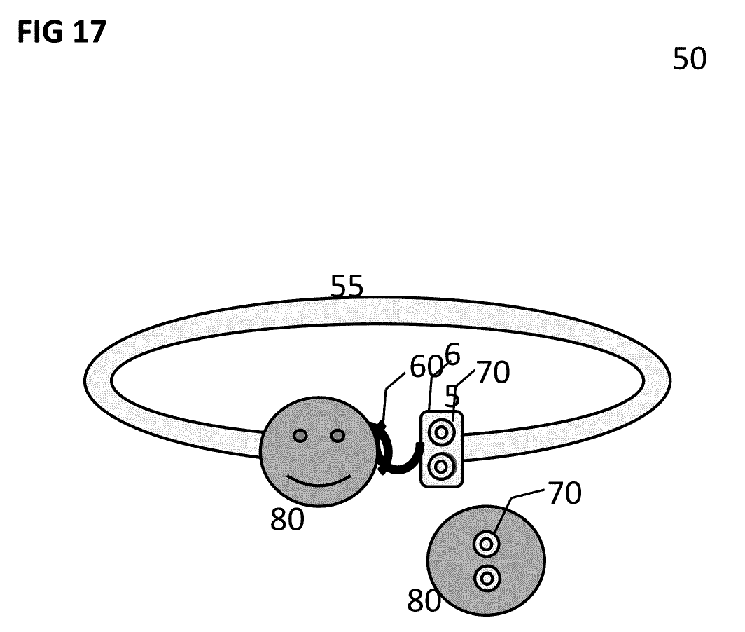

FIG. 18 is a schematic view of one embodiment of the invention showing the support member.

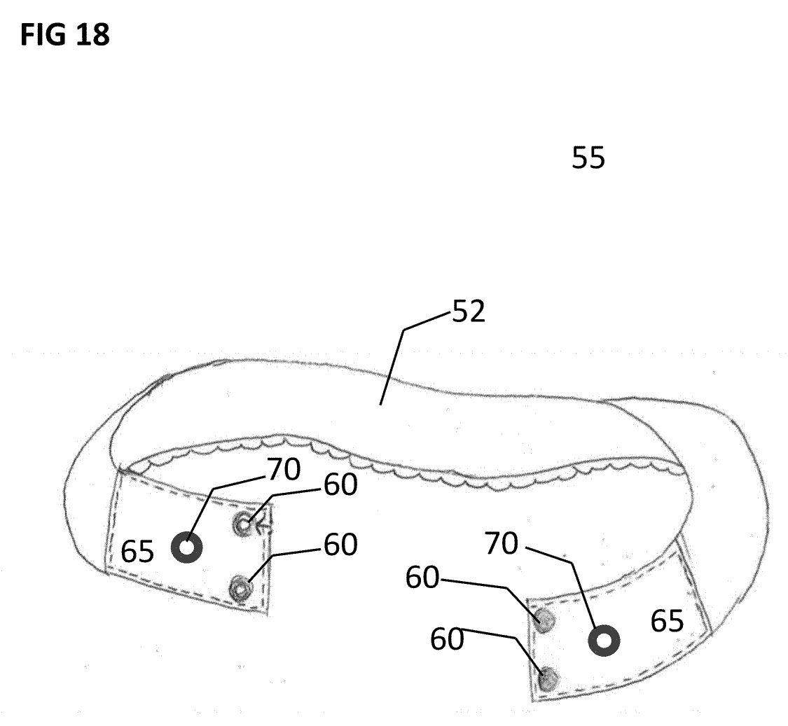

### DETAILED DESCRIPTION OF PREFERRED EMBODIMENTS

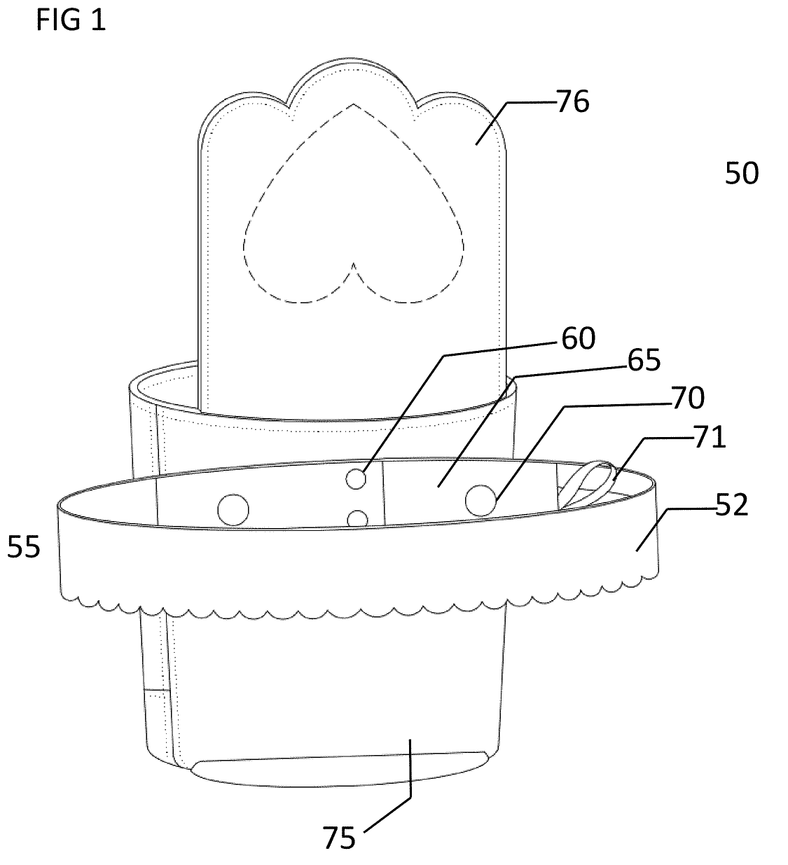

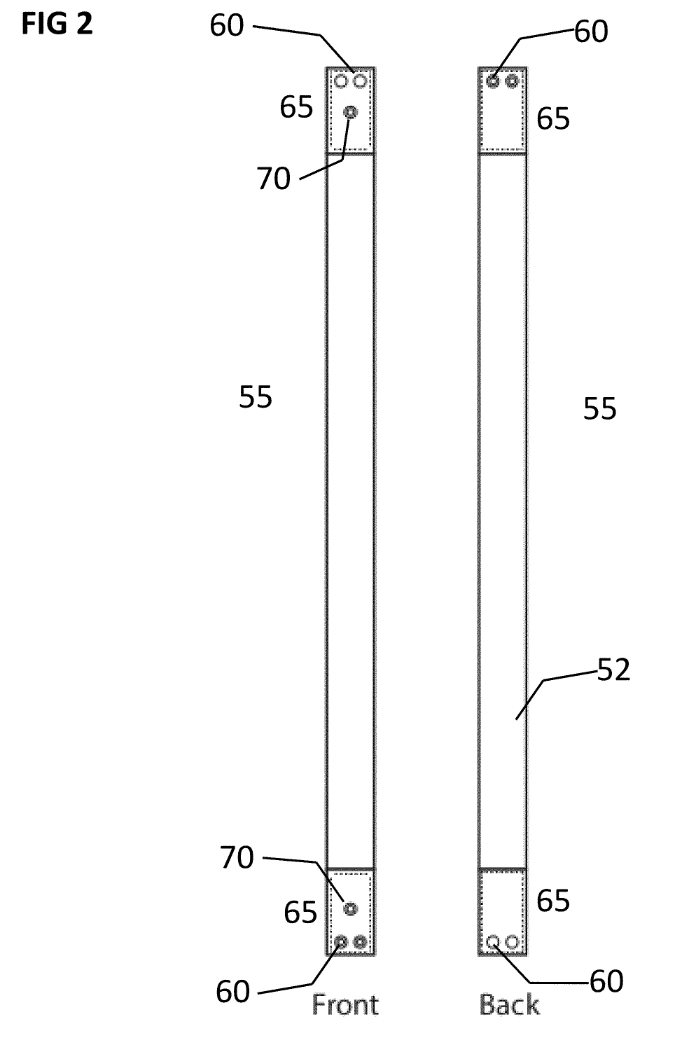

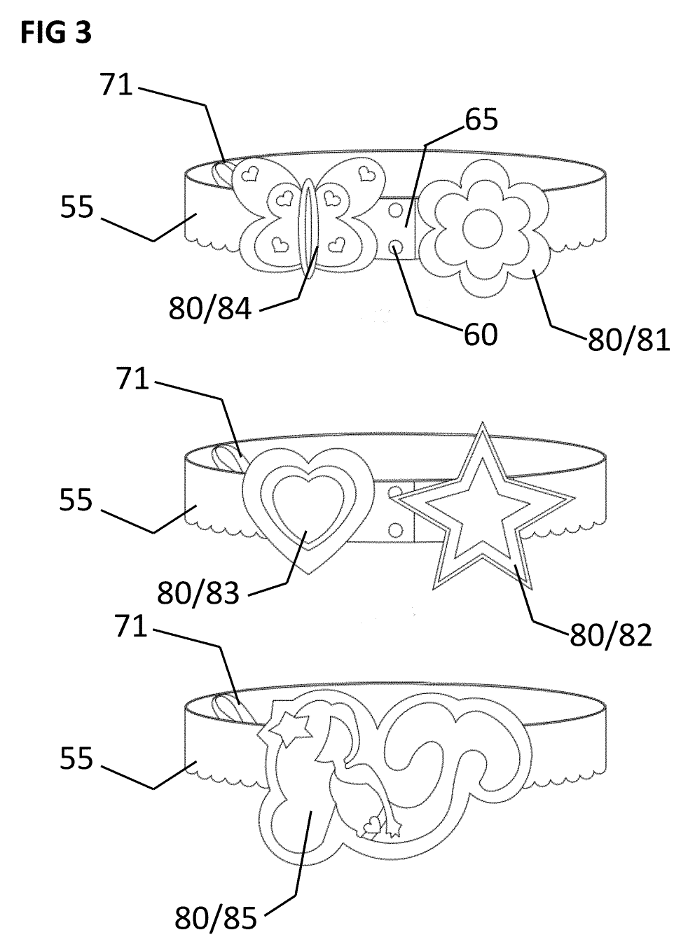

The current invention presents a wearable customizable belt system that can be interchanged by the user to reflect their own tastes, FIG. 1. The interchangeable belt system 50 involves a support member 55 comprising a belt 52, which fastens around a body part of the user, each end having an attachment member 65 with two or more fasteners, FIG. 2. In the preferred embodiment, the support member 55 is made of an elastic material and fastens around the waist of the user, a child. At least one fastener on each attachment member 65 configured to fasten to at least one fastener on the opposing attachment member 65 of the support member 55, these are the support member fasteners 60. Additionally, at least one faster on each attachment member 65 configured to fasten to at least one fastener on an interchangeable, removable attachment piece, these are the adornment fasteners 70. The interchangeable removable attachment pieces can be either a pouch or bag 75, or an adornment element 80. The above can be seen in FIGS. 1-3. The one or more adornment fasteners 70 on the opposing attachment members 65 of the belt, are in close proximity to each other when the belt is fastened, FIG. 3.

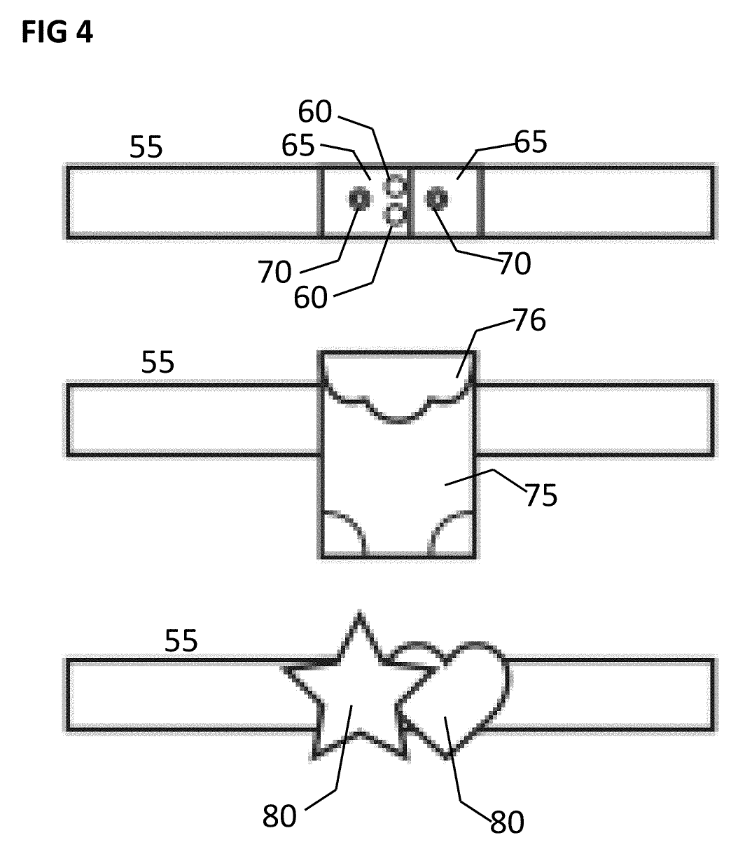

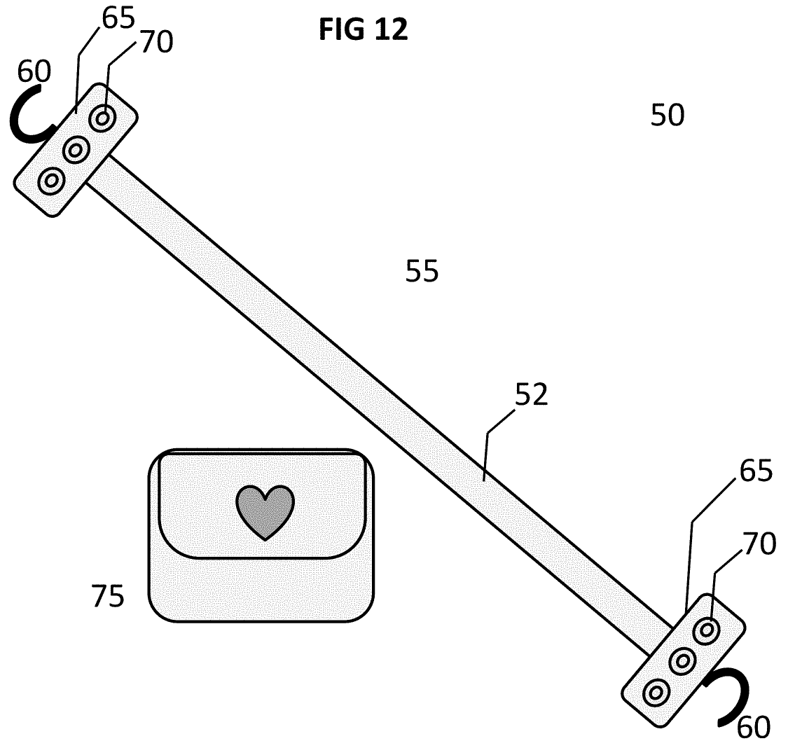

The support member 55 is secured around the user, a child, using the support member fasteners 60. The support member 55 can be further secured around the body of the child with an interchangeable pouch or bag 75 which attaches to the two or more adornment fasteners 70, at least one of which is on each attachment member 65. The bag 75 attaches to the support belt 55 across the support member fasters 60 of the belt, thereby making the belt more securely fastened around the child FIG. 12. In the preferred embodiment of the invention the support member fasteners 60 for the belt are simple and can be easily operated by a child. By employing multiple redundant fasteners 60, 70, each of the fasteners individually can easier to disengage. The possible support member fasters include but are not limited to: a snap fastener male portion, a snap fastener female portion, permanent magnet, a magnetically attractable member, a piece of hook material, a piece of loop material, button, clasp, hook and loop, hook and hook, or hook and click closure. Once the support member 55 is secured around the child, they may operate the possibly more difficult adornment fasteners 70. In the preferred embodiment, the adornment fasteners 70 are snap closures, but may also be any other suitable fastening mechanism. Many young children have difficulty operating or properly aligning snap closures, which is why they are often not used in articles that children must use themselves. By allowing the child to first fasten the support member 55 and then operate the remaining part of the closure system 70 while the support member 55 is secured to and supported by the child, the child is able to take additional time to operate the more difficult fasteners 70. The pouch 75 may have many different variations including but not limited to designs with open tops, draw strings, magnetic closures, versions with electronics added, and much more. Additionally, to add to the child-friendly aspect of the invention, the bag 75 can optionally be left off of the support member 55, and instead one or more adornment elements 80 may be attached to the belt. These decorations, as seen in FIG. 4, can attach to one or more of the attachment points, and may attach to one or more of the attachment members 65 of the support belt 55.

A preferred embodiment of the interchangeable belt system 50 includes a support member 55, one or more interchangeable adornment elements 80 and one or more interchangeable bags 75. The belt system 50 may have one or more adornment elements 80 or bags 75 manually attached to, or removed from, the support member 55 whenever a user may desire without the use of tools or undue effort. In the preferred embodiment of the support member 55, a first attachment member 65 is permanently attached to one end of a support belt 52. A second attachment member 65 is permanently attached to the opposing end of the support belt 52. The first and second attachment members 65, may be affixed to the support belt 52 by adhesive bonding, swaging, crimping, sewing, soldering, welding, brazing, riveting, or by engagement of male and female fasteners, such as screws, clips, or snap rivets, around or through the support belt 52. Each attachment member 65 has one or more support member fasteners 60 and one or more adornment fasteners 70 affixed to it. The support member 55 fastens around a user by attaching the support member fasteners 60 found on the attachment member 65 to the support member fasteners 60 at the opposing attachment member 65. In certain embodiments, the adornment and support member fasteners 70, 60 may be attached to the attachment members 65 by means including but not limited to: adhesive bonding, swaging, crimping, sewing, soldering, welding, brazing, riveting, or by engagement of male and female fasteners, such as screws, clips, or snap rivets, around or through the attachment member 65.

The fasteners 60 or 70 may be of a type having a pair of mutually mateable attachment elements adapted to be manually, quickly, easily, selectively be either disengaged from one another or engaged with one another so as to be securely mechanically connected to one another whenever a user may desire. In the case of a magnetic fastener, one of the fasteners 60 or 70 would include a permanent magnet while the other of the fasteners 60 or 70 would include a magnetically attractable member. The magnetically attractable member may either be a permanent magnet, appropriately polarized and oriented for mutual attraction with permanent magnet, or may be a piece of a material, such as iron or steel, which is attractable by a permanent magnet without itself necessarily being permanently magnetized.

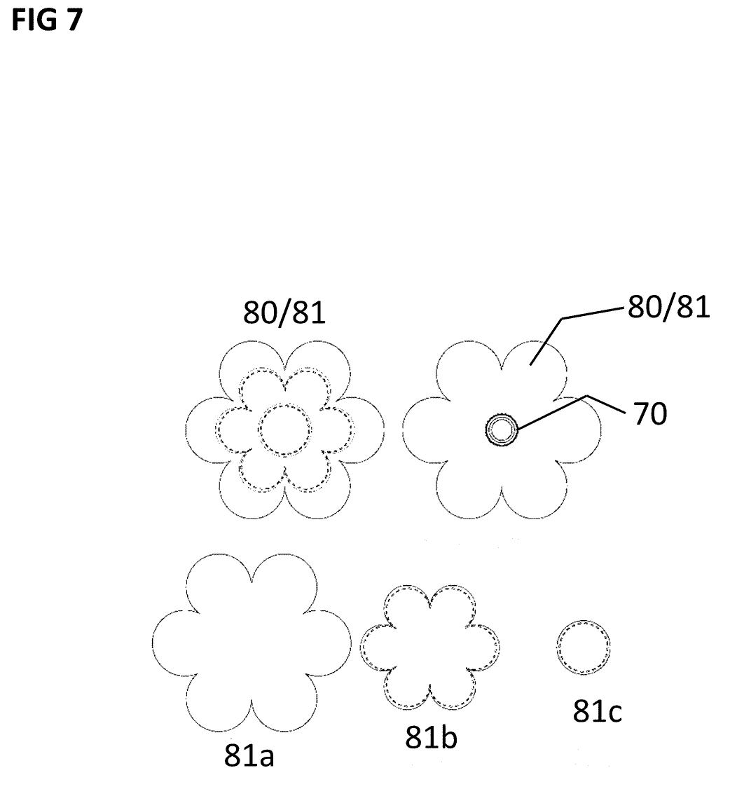

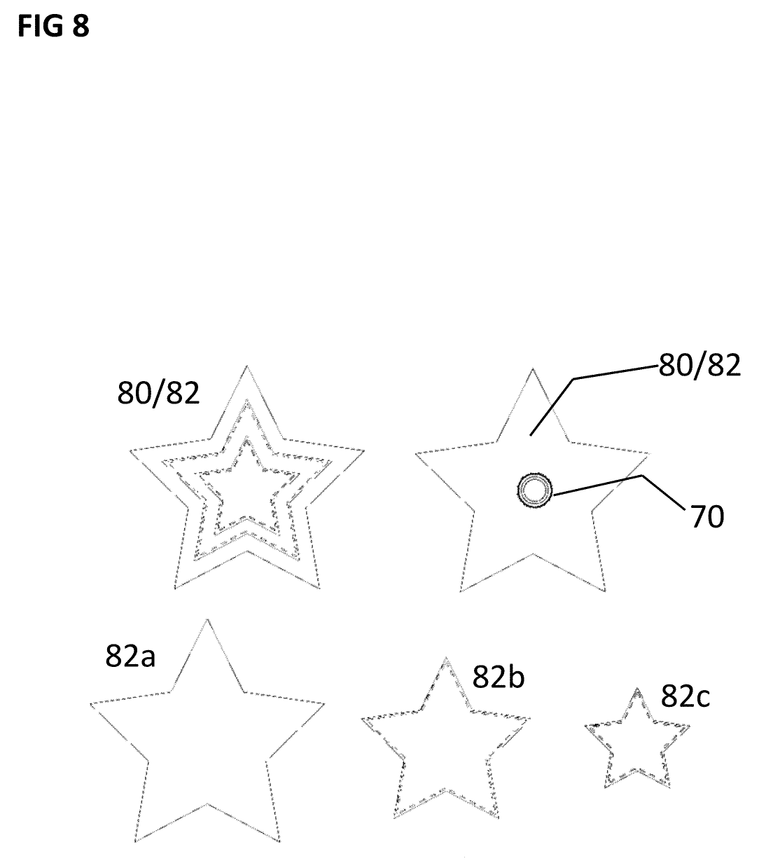

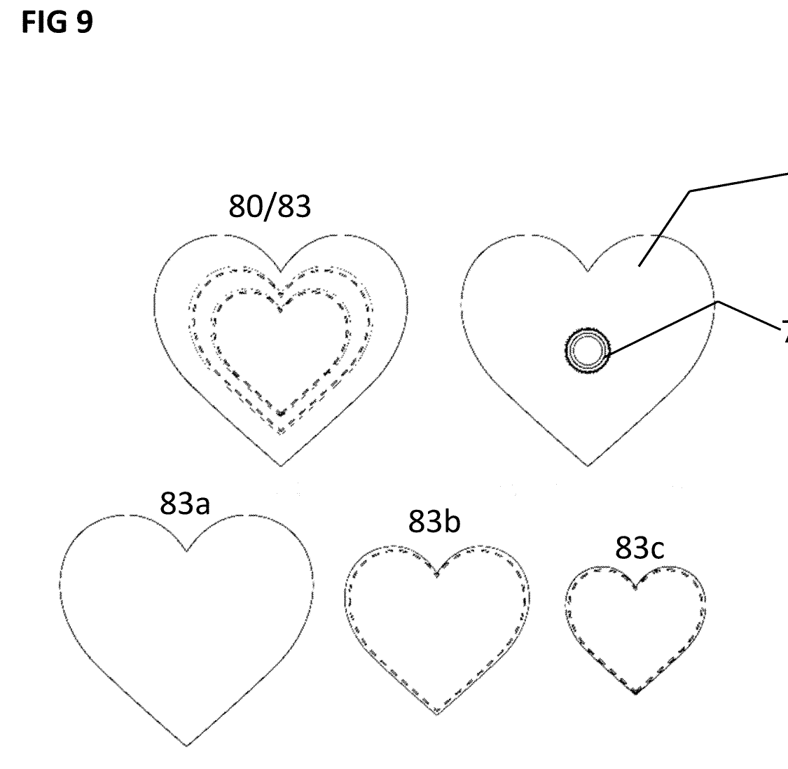

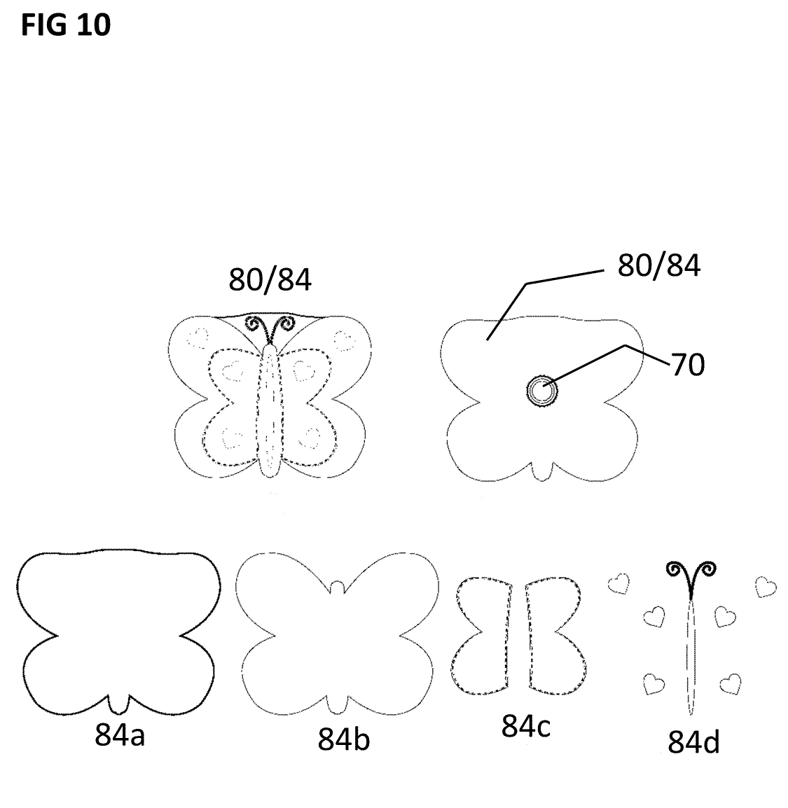

An adornment 80 may comprise any form of ornamentation. By way of non-limiting examples, in certain embodiments adornment 80 may comprise any of the following, either alone or in any combination or sub-combination: an artificial flower, a bow, a ribbon, a gem, an artificial gem, one or more beads, one or more feathers, a representation of a creature, a representation of an animal, a representation of an insect, a representation of a plant, a representation of a flower, a representation of a character, glitter, fabric, or plastic adornments, or any other suitable articles or materials for ornamentation. The illustrations of adornment elements in the drawings, such as an artificial flower 81, star 82, heart 83, butterfly 84, and representation of a character or creature 85, are schematic in nature and are not to be construed as limiting as to size, shape, color, selection of materials and/or portrayal of any particular appearance or ornamental design. A ribbon, flower, creature, animal, feather, or character may be of any desired size, shape and/or material and may be arranged in any manner. In the preferred embodiment, an adornment is comprised of 3 or more layers of fabric material, as seen in FIGS. 7-10.

Representation of creature 85 may suitably comprise any two-dimensional or three-dimensional representation of any type of creature including, without limitation, a human, bird, animal, fish, insect, reptile, amphibian, invertebrate or otherwise. Representation of creature 85 can be, but need not necessarily be, a lifelike representation. Representation of character 85 may suitably comprise any two-dimensional or three-dimensional representation of any type of imaginary character including, without limitation, a cartoon character, literary character, mythological character, monster, ghost, comic book character, movie character or the like.

In certain embodiments, adornment 80 and adornment fastener 70 may optionally be formed as an integral, or substantially integral, unit such as by casting or molding both parts as a unit. In certain embodiments, adornment fastener 70 and adornment 80 may be permanently attached directly to one another such as by adhesive bonding, sewing, swaging, crimping, soldering, welding, and/or brazing as non-limiting examples

While the invention has been described with reference to various preferred embodiments, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed but that the invention will include all embodiments falling within the scope of the appended claims, either literally or under the Doctrine of Equivalents.

1) A device comprising:
a) a support element, which fastens around the waist, arm, or other body part,
b) the support element comprising a belt, each end comprising two or more fasteners, which may comprise any of the following: a snap fastener male portion, a snap fastener female portion, hook, loop, permanent magnet, a magnetically attractable member, a piece of hook material, a piece of loop material, button, or clasp;
a. at least one fastener on each end configured to fasten to at least one fastener on the opposing end of the support member
b. at least one faster on each end configured to fasten to at least one fastener on an interchangeable, removable attachment piece,
c) an interchangeable, removable attachment piece which attaches across the two ends of the support element.

2) A device in which the attachment piece of claim 1 is a purse, pouch or other container device.

3) A device in which the attachment piece of claim 1 is a decorative adornment.

4) An adornment as claimed in claim 3, wherein the adornment is selected from the group consisting of: an artificial flower, a bow, a ribbon, a gem, an artificial gem, one or more beads, one or more feathers, a representation of a creature, a representation of an animal, a representation of an insect, a representation of a plant, a representation of a flower, a representation of a character, glitter, or plastic adornments.

5) A device in which the attachment piece of claim 1 has one or more electronic decorations.

6) A device in which the electronic decorations of claim 5 is one or more LED decorations.

7) the device of claim 1 wherein the one or more fasteners configured to fasten to the one or more fasteners opposing end of the support member are different from those configured to fasten to the one or more fasteners on the interchangeable, removable attachment piece.

8) The device of claim 7 where the fasteners configured to fasten to the one or more fasteners on the interchangeable, removable attachment piece require more force to operate than the fasteners configured to fasten to one or more fasteners on the opposing end of the support member.
